(19) United States
(12) Patent Application Publication
(10) Pub. No.: US 2016/0027032 A1
(43) Pub. Date: Jan. 28, 2016

(54) Invitation Tag

(71) Applicant: Benjamin Yip, Walnut, CA (US)

(72) Inventor: Benjamin Yip, Walnut, CA (US)

(21) Appl. No.: 14/338,257

(22) Filed: Jul. 22, 2014

(51) Int. Cl. G06Q 30/02

(52) U.S. Cl. CPC G06Q 30/0215

(57) ABSTRACT

An invitation tag has a substrate and a vendor account activation code displayed on the substrate. The vendor account activation code is configured to direct a vendor to create a vendor account on an administrative server. The administrative server is configured to administrate a beneficiary account, the vendor account and a supporter account. The beneficiary account includes beneficiary information and beneficiary user account settings and beneficiary account bank information so that the administrative server can send instructions to financial institutions to direct funds to the beneficiary account. The invitation tag optionally has a unique randomly generated identification number that associates the vendor account to the beneficiary account and the supporter account. The invitation tag may also have beneficiary account indicia identifying the beneficiary and supporter account indicia identifying the supporter.

### FIELD OF THE INVENTION

The present invention is in the field of invitation tags.

### DISCUSSION OF RELATED ART

Varying types of rebate programs have been administrated on computer networks for different purposes. Some rebate programs focus on non-profit agendas, and some enable people to save for the future whether it is for a college education or a retirement account. For example, inventor Hardesty describes a savings program in U.S. Pat. No. 6,592,030, issued Jul. 15, 2003, entitled Financial Transaction System with Retirement Saving Benefit, the disclosure of which is incorporated herein by reference. Hardesty describes a rebate program for the benefit of participating individuals such as wage earners. Eligible individuals are issued a card with an identifiable account number using credit approval systems. Rebate is calculated and transferred to participant's account in a trust fund, and disbursement occurs automatically upon specified events. Another example of a savings program is Sullivan's U.S. Pat. No. 6,941,279, issued Sep. 6, 2005, entitled Mutual Fund Card Method and System, the disclosure of which is incorporated herein by reference. Sullivan teaches a method and system where a rebate is calculated periodically and applied to an investment account for the benefit of the approved customer.

Inventor Barton in U.S. Pat. No. 6,164,533, issued on Dec. 26, 2000, entitled Point of Sale Automatic Savings Program Contribution System, the disclosure of which is incorporated herein by reference, describes a savings program. Barton teaches about a system provided for automatically contributing monies to a savings program upon making a purchase. Barton's invention includes an input device for generating an identification signal for an identifying account holder, a service provider connected to the input device for receiving the identification signal, and a saving program provider, which is connected to the service provider for receiving the signal representative of the savings program contribution amount. Similar to Barton's patent is inventor Thompson U.S. Pat. No. 7,499,872, issued Mar. 3, 2009, entitled Methods and Systems for Applying Rebates to Higher Education, the disclosure of which is incorporated herein by reference. Thompson discloses an invention relating to methods and systems for funding a college education by accumulating and managing merchant rebates. In particular, Thompson's invention is to facilitate retail transactions between an organization registered members and selected merchants who offer rebates, so that the rebates are accumulated and provided for a college education.

### SUMMARY OF THE INVENTION

The present invention is a configuration of an administrative server to generate a physical invitation tag for providing funds to a beneficiary upon purchases. An invitation tag has a substrate and a vendor account activation code displayed on the substrate. The vendor account activation code is configured to direct a vendor to create a vendor account on an administrative server. The administrative server is configured to administrate a beneficiary account, the vendor account and a supporter account. The beneficiary account includes beneficiary information and beneficiary user account settings and beneficiary account bank information so that the administrative server can send instructions to financial institutions to direct funds to the beneficiary account. The invitation tag optionally has a unique randomly generated identification number that associates the vendor account to the beneficiary account and the supporter account. The invitation tag may also have beneficiary account indicia identifying the beneficiary and supporter account indicia identifying the supporter.

The rebate coupon has rebate coupon data that has various portions which include a rebate tier and a coupon tier, wherein the rebate tier includes data including: a rebate amount; a purchase balance amount for the rebate tier; and a payment amount for the rebate tier, and wherein the coupon tier data includes: a coupon amount; a purchase balance coupon tier amount; and a payment amount coupon tier. The rebate coupon data further includes a total purchase amount.

The total purchase amount equals the payment amount rebate tier plus the payment amount of the coupon tier, wherein the payment amount of the coupon tier equals the purchase balance of the coupon tier plus the coupon amount. The payment amount of the rebate tier equals the purchase balance of the rebate tier plus the rebate amount. The rebate amount equals a funding amount plus a handling fee.

The rebate tier is the first tier and provides a rebate that the administrative server automatically generates instructions to transfer to a beneficiary financial institution by EFT and also to a administrator financial institution by EFT. A percentage of the rebate and a percentage of the handling fee add up to 100% and can be preset on the administrative server in the administrator account.

### BRIEF DESCRIPTION OF THE DRAWINGS

FIG. 1 is a front view of the invitation tag.

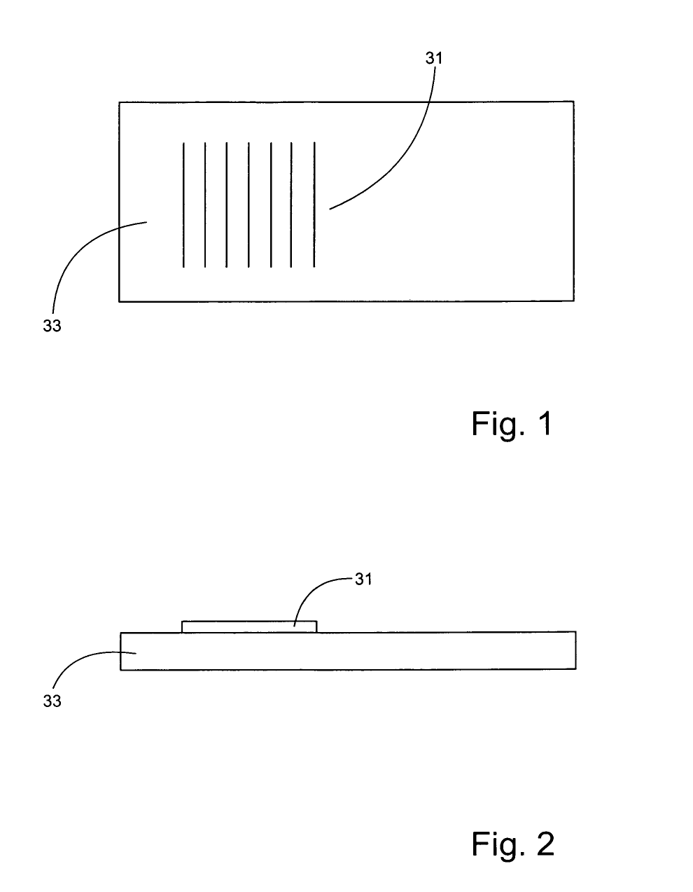

FIG. 2 is a side view of the invitation tag.

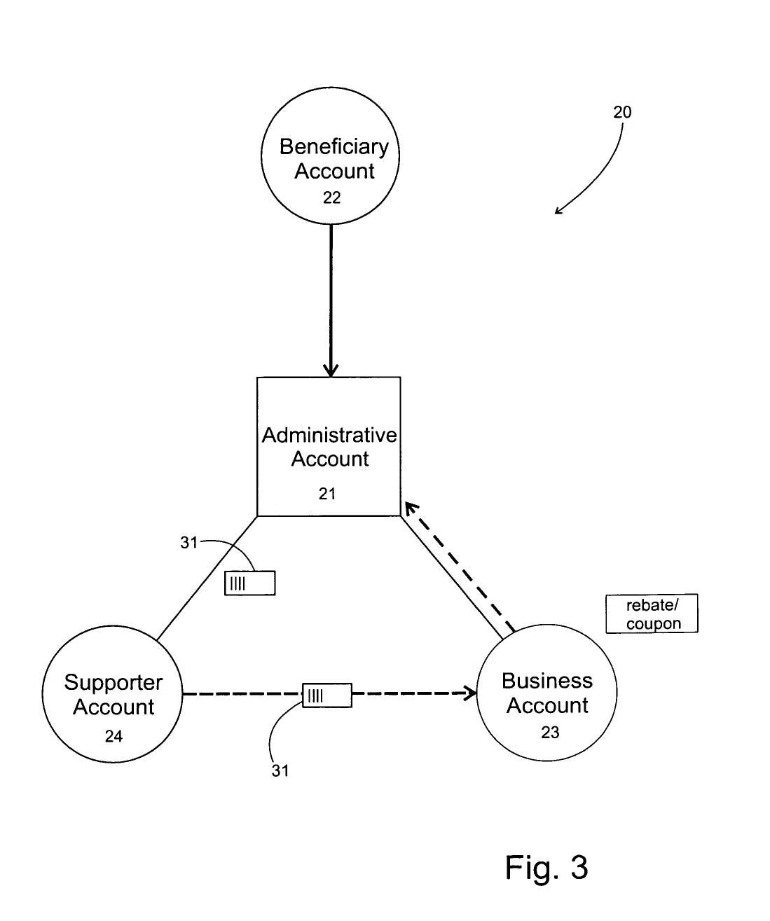

FIG. 3 is a diagram of the relationship of user accounts that are established using the invitation tag.

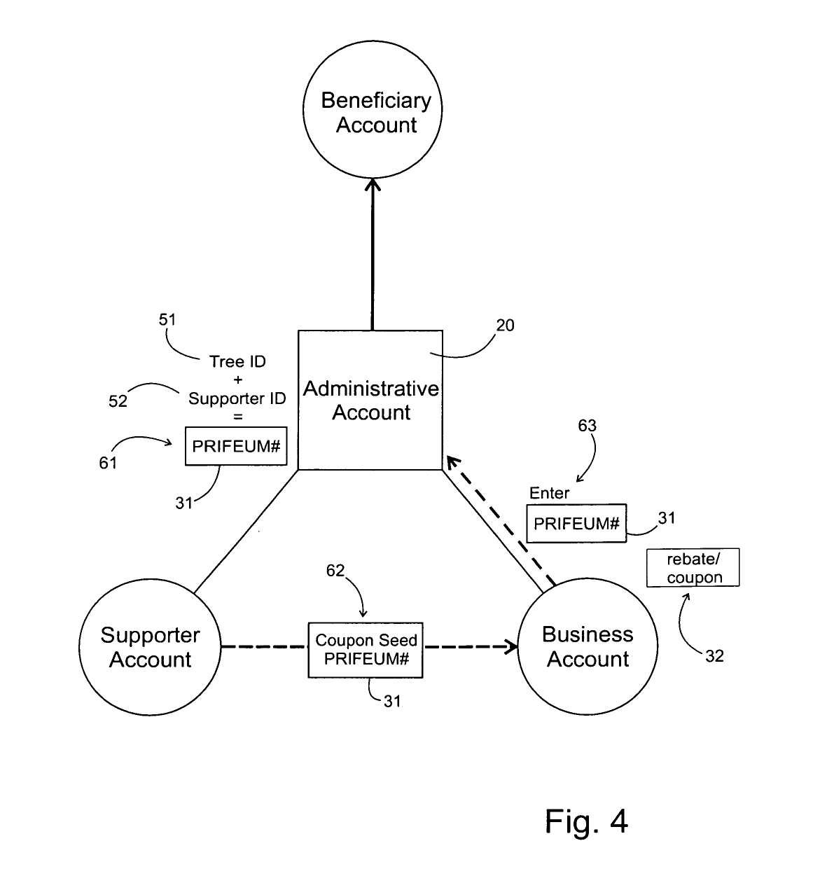

FIG. 4 is a flowchart diagram of the steps of using the invitation tag.

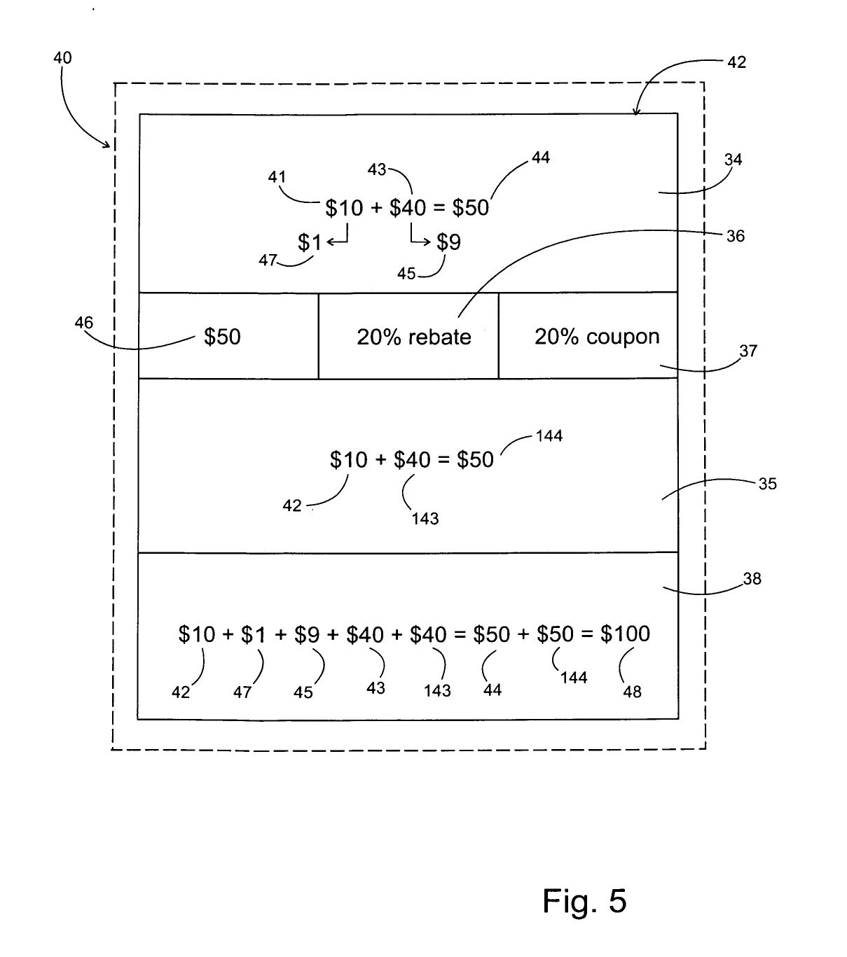

The following callout list of elements can be a useful guide in referencing the elements of the drawings.
20 Administrative Server
21 Administrator Account
22 Beneficiary Account
23 Vendor Account
24 Supporter Account
31 Vendor Account Activation Code
32 Rebate Coupon
33 Invitation Tag
34 Rebate Tier
35 Coupon Tier
36 Rebate Percentage
37 Coupon Percentage
38 Receipt Totals Data
40 Database
41 Rebate Amount
42 Coupon Amount
43 Purchase Balance
143 Purchase Balance Coupon Tier
44 Payment Amount
144 Payment Amount Coupon Tier
45 Funding Amount
46 Breakpoint
47 Handling Fee
48 Total Purchase Amount
61 Generation Step
62 Transmission Step
63 Redemption Step
64 Rebate Coupon Generation Step

### DETAILED DESCRIPTION OF THE PREFERRED EMBODIMENT

The present invention is an invitation tag that facilitates and combines charitable donations with coupon savings. In this way, the supporter generates charitable donations to their charity while also receiving coupon savings. Businesses receive notoriety and additional revenue. The supporter receives the invitation tag 33 at a generation step 61. The generation step 61 may include e-mailing a supporter a graphic image of the invitation tag 33 so that the supporter can print out the invitation tag 33 using various substrates such as cards, T-shirts and letters. The supporter then passes out the invitation tag 33 in a transmission step 62. A business may redeem the invitation tag 33 during a redemption step 63 and then proceed to set parameters and generate a rebate coupon 32 during a rebate coupon generation step 64. After the rebate coupon generation step 64, rebate coupons can be purchased by various supporters and then taken to businesses where they are verified and where the total purchase price is deducted from the receipt of the business.

The present invention includes an administrative server 20 that has an administrative account 21 which administrates various accounts for various user accounts. User accounts include a beneficiary account 22, a vendor account 23 and a supporter account 24. A beneficiary account is designed to be established by an individual or group, or a for-profit or nonprofit organization which can be verified or unverified. The beneficiary account is configured by an administrator. The beneficiary account can include beneficiary information such as a user ID number, password, beneficiary user account settings and beneficiary account bank information so that the administrative server can send instructions to financial institutions to direct funds to the beneficiary account.

A supporter account is created using typical account generation methods. When a supporter wants to support a beneficiary with contributions to the beneficiary account, the administrative server 20 can create an invitation tag 33 for the supporter account either automatically, or at the direction of the supporter during the generation step 61. The invitation tag also includes a vendor account activation code 31 which can be sent to various vendors for soliciting their support. The invitation tag can be a unique randomly generated identification number or a string of characters that identifies and makes a link between the beneficiary account and the supporter account. The invitation tag tracks an individual supporter's efforts to add vendors to the beneficiary account that the supporter has chosen.

The invitation tag 33 facilitates the addition of multiple vendors so as to create a branching tree structure where the vendors support the beneficiary account 22. The invitation tag may be linked to tracking information which optionally tracks supporters as a group, and maintains data regarding general demographic information penetration in request for support. Tracking information can also allow monitoring of the progress of a beneficiary account with different geographic locations to see their fundraising efforts. The invitation tag 33 can also have indicia identifying the beneficiary account 22 or the beneficiary and optionally the supporter account 24 or the supporter.

During the transmission step 62 the invitation tag 33 can fold flat for mailing. Preferably, the vendor account activation code 31 is visible and printed on the invitation tag 33. The invitation tag 33 can be integrated with other paper folding technologies such as pop-up invitations and cards. The invitation tag 33 can be a card that has built in sound, lights or other special effects.

During the redemption step 63, the vendor account 23 is created by typing in the vendor account activation code 31 located on the invitation tag which facilitates an invitation to create and then modify the vendor account. The invitation tag is a physically requested invitation for an electronically unique membership. The invitation tag can be printed on a sheet such as a fabric or paper sheet so that a business can easily receive it and retain it for future redemption during the redemption step 63. The invitation tag can be printed on a card such as a business card. The invitation tag 33 has a vendor account activation code imprinted on a display surface of the invitation tag. A vendor such as a local grocery can use the activation code to establish a vendor account. The activation code could be a barcode or QR code for example and could be scanned with a smart phone to direct the vendor to create an account on the administrative server. The vendor account activation code 31 on the invitation tag 33 allows the vendor account to be automatically linked to the beneficiary account 22 and optionally also the supporter account 24.

The vendor account set up by the invitation tag 33 provides an option for the vendor user to generate a rebate coupon on the administrative server database. The rebate bonus is configured with a rebate tier and a coupon tier and stored on the database 40 as rebate coupon data 42 after the activation of the invitation tag 33 by a vendor to create a vendor account 23. The invitation tag may have a barcode or QR code that sends the business to a sign-up page on the administrator server website where the business can sign up and create a vendor account. The invitation may also have a human readable code such as a number or string of characters that the business can input into a sign-up page to create a vendor account.

Rebate coupon data 42 has various portions which includes a rebate tier 34 and a coupon tier 35. The rebate tier includes data such as a rebate amount 21, a purchase balance amount for the rebate tier 43 and a payment amount for the rebate tier 44. The coupon tier data 35 includes a coupon amount 42 a purchase balance coupon tier amount 143 and a payment amount coupon tier 144. The total purchase amount 48 is also a part of the rebate coupon data 42. The total purchase amount 48 equals the payment amount rebate tier 44 plus the payment amount of the coupon tier 144. The payment amount of the coupon tier equals the purchase balance of the coupon tier 143 plus the coupon amount 42. The payment amount of the rebate tier 44 equals the purchase balance of the rebate tier 43 plus the rebate amount 41. The rebate amount 41 equals the funding amount 45 plus the handling fee 47.

The rebate tier is the first tier and provides a rebate that the administrative server automatically transfers to the beneficiary bank institution and also to the administrator bank account. The percentage of the rebate and the percentage of the handling fee add up to 100% and can be preset by the administrative server 20 through the administrator account 21.

The rebate coupon 32 can also be a printed coupon, or can be available online. The rebate coupon 32 can also be identified by one or more rebate coupon identifier codes.

The coupon tier gives the supporter shopper a bonus such as a discount on products, or a bonus item. The database may further include a coupon amount 42 that represents the amount a user will save. The coupon amount 42 can also refer to a dollar value of a coupon which can be a physical coupon or an electronic coupon code for redeeming a free item such as a T-shirt that supports the cause, or is related to the business.

For example, as seen in FIG. 5, a variety of different rebate coupon data can be collected. The rebate coupon data 42 can have a $10 rebate amount 41 and a $40 purchase balance of the rebate tier about 43. The rebate amount plus the purchase balance amount equals the $50 payment amount of the rebate tier 44. In this case, a user spends $10 to purchase a rebate amount 41. The rebate amount 41 is split into a $9 funding amount 45 and a $1 handling fee 47. The rebate coupon data also includes a rebate percentage 36 set at 20% and a coupon percentage 37 set at 20% also. The $50 breakpoint 46 is also included in the rebate coupon data 42.

The vendor account has the option to set parameters that are stored as the rebate coupon data 42. The first portion of the $100 total purchase amount 48 is the rebate tier 34. The rebate tier 34 allows the consumer to purchase a $10 rebate which the administrative server partitions into a nine dollar funding amount 45 with a $1 handling fee 47. The nine dollar funding amount 45 is directed to the beneficiary bank account at regular intervals or upon request. The handling fee 47 is retained by or sent to the administrative account bank account.

The supporter can be a consumer that purchases $50 of goods and pays $10 to purchase the rebate coupon having a rebate amount 41 on a website hosted by the administrative server 20 and operated via the administrative account 21. The administrative server is configured to first receive the $10 rebate coupon purchase which then can be redeemed by consumer with the business to decrease the cost of the purchase of an item from the business.

The user also has the option to purchase more than the amount of a $50 breakpoint 46 such as by purchasing a total of $100. The payment amount exceeding the breakpoint 46 is the $50 payment amount of the coupon tier 144 which equals the $10 coupon amount 42 that the user saves plus the $40 purchase balance coupon tier 143 that the user additionally spends over the amount of the $50 breakpoint 46.

The data is optionally summarized as a receipts totals data set 38 as seen in FIG. 5. The receipts totals data set 38 includes the $10 coupon amount 42, the one dollar handling fee 47, the nine dollars funding amount 45, the $40 purchase balance of the rebate tier 43, the $40 purchase balance of the coupon tier 143, the $50 payment amount of the rebate tier 44, the $50 payment amount of the coupon tier 144 and the total purchase amount 48. The data located in the receipts totals data set 38 can be archived for long-term storage and accounting records. The administrative server is preferably configured to provide electronic fund transfer (“EFT”) instructions so that the one dollar handling fee is retained in an administrative bank account while the nine dollar funding amount is sent by EFT to the beneficiary bank account.

Additionally, the database can provide error checking by cross referencing and comparing various fields to check to see if the amounts are correct. The rebate coupon has a rebate tier 34 and an optional coupon tier 35 which the administrative server 20 can compute separately or together. The rebate tier includes data such as a rebate amount 41, a purchase balance amount for the rebate tier 43 and a payment amount for the rebate tier 44 which can all be compared with each other. The coupon tier data 35 includes a coupon amount 42 a purchase balance coupon tier amount 143 and a payment amount coupon tier 144 which can also be compared with each other. The total purchase amount 48 is also a part of the rebate coupon data 42. The total purchase amount 48 equals the payment amount rebate tier 44 plus the payment amount of the coupon tier 144. The payment amount of the coupon tier equals the purchase balance of the coupon tier 143 plus the coupon amount 42. The payment amount of the rebate tier 44 equals the purchase balance of the rebate tier 43 plus the rebate amount 41. The rebate amount 41 equals the funding amount 45 plus the handling fee 47. In case the amounts do not match up, or appear to be outliers such as a large gross amount, the database may also retain fields that flag potential anomalies and automatically report such potential anomalies to the administrative account 21 for human bookkeeping review. Such reporting can be by an indicator such as a pop-up window on a graphical user interface of the administrative server or a list of potential anomalies that need to be reviewed and cleared.

The administrative server 20 can track statistics on redeemed invitation tags. This may allow administration of a fund-raising event where a supporter or beneficiary can receive a recognition or reward for a high level of invitation tags redeemed by vendors. For example, the administrative server can query the database for invitation tag redemption data and provide a list of supporter leaders or beneficiary leaders on a leaderboard for most redeemed invitation tags.

1. An invitation tag comprising:
a. a substrate; and
b. a vendor account activation code displayed on the substrate, wherein the vendor account activation code is configured to direct a vendor to create a vendor account on an administrative server, wherein the administrative server is configured to:
i. administrate a beneficiary account, the vendor account and a supporter account;
ii. wherein the beneficiary account includes beneficiary information and beneficiary user account settings and beneficiary account bank information so that the administrative server can send instructions to financial institutions to direct funds to the beneficiary account.

2. The invitation tag of claim 1, wherein the invitation tag is a unique randomly generated identification number that associates the vendor account to the beneficiary account and the supporter account.

3. The invitation tag of claim 1, wherein the invitation tag also has beneficiary account indicia identifying the beneficiary and supporter account indicia identifying the supporter.

4. The invitation tag of claim 1, wherein the administrative server is configured to provide EFT instructions so that a handling fee is retained in an administrative bank account while a funding amount is sent by EFT to a beneficiary bank account.

5. The invitation tag of claim 1, wherein the vendor account activation code is imprinted on the invitation tag as a machine-readable barcode or QR code that sends the business to a sign-up page on the administrator server website where the business can sign up and create a vendor account.

6. The invitation tag of claim 1, wherein redemption of the vendor account activation code is configured to generate a rebate coupon on the administrative server database after the vendor account activation code is generated, wherein the rebate coupon has a rebate tier and a coupon tier and stored on the database as rebate coupon data.

7. The invitation tag of claim 6, wherein the rebate coupon has rebate coupon data that has various portions which include a rebate tier and a coupon tier, wherein the rebate tier includes data including: a rebate amount; a purchase balance amount for the rebate tier; and a payment amount for the rebate tier, and wherein the coupon tier data includes: a coupon amount; a purchase balance coupon tier amount; and a payment amount coupon tier.

8. The invitation tag of claim 7, wherein the rebate coupon data further includes a total purchase amount.

9. The invitation tag of claim 8, wherein the total purchase amount equals the payment amount rebate tier plus the payment amount of the coupon tier, wherein the payment amount of the coupon tier equals the purchase balance of the coupon tier plus the coupon amount, wherein the payment amount of the rebate tier equals the purchase balance of the rebate tier plus the rebate amount, wherein the rebate amount equals a funding amount plus a handling fee.

10. The invitation tag of claim 9, wherein the rebate tier is the first tier and provides a rebate that the administrative server automatically generates instructions to transfer to a beneficiary financial institution by EFT and also to a administrator financial institution by EFT, wherein a percentage of the rebate and a percentage of the handling fee add up to 100% and can be preset on the administrative server in the administrator account.
